(19) United States
(12) Patent Application Publication
(10) Pub. No.: US 2006/0225358 A1
(43) Pub. Date: Oct. 12, 2006

(54) Apparatus and method for providing a drive device for a vehicle door

(76) Inventors: Ronald H. Haag, Lake Orion, MI (US); Joseph M. Johnson, Huntington Woods, MI (US); Brian N. Orr, Chesterfield, MI (US)

Correspondence Address: DELPHI TECHNOLOGIES, INC., M/C 480-410-202, PO BOX 5052, TROY, MI, 48007, US

(21) Appl. No.: 11/400,250

(22) Filed: Apr. 7, 2006

Related U.S. Application Data
(60) Provisional application No. 60/670,171, filed on Apr. 11, 2005.

(51) Int. Cl. E05F 11/00

(52) U.S. Cl. 49/360

(57) ABSTRACT

A drive assembly for a vehicle door, comprising: a motor having a driving member; a housing having a shaft rotatably received therein; an input member being rotatably received upon the shaft, the input member being operatively associated with the driving member, wherein rotation of the driving member causes rotation of the input member; an armature mounted on the input member; a rotor fixedly secured to the shaft, the rotor being cylindrical in shape and has a plurality of teeth positioned along the periphery of the rotor, the teeth being positioned in an equidistant manner; a coil mounted to the housing, the coil providing magnetic flux lines through the rotor to attract the armature when the coil is energized; and an inductance sensor assembly mounted to the housing in a facing spaced relationship with respect to the plurality of teeth of the rotor, wherein rotational speed and direction of the rotor is detected by the inductance sensor assembly.

### CROSS REFERENCE TO RELATED APPLICATIONS

This application claims the benefit of U.S. provisional patent application serial No. 60/670,171, filed Apr. 11, 2005, the contents of which are incorporated herein by reference thereto.

### TECHNICAL FIELD

The present invention relates to an apparatus and method for providing a driving mechanism for a vehicle door. More particularly, the present invention relates to a driving mechanism with a sensing assembly for providing a signal indicative of movement of the vehicle door.

### BACKGROUND

A typical vehicle is manufactured with a plurality of openable doors. Each door is typically mounted on hinges within a door opening. Some larger vehicles have sliding doors that slide from an open position to closed position thus, egress and ingress of the vehicle is possible without requiring a large open area beside the vehicle to allow for pivoting of the door. This is particularly useful in parking lots where the area between the vehicles is typically not large enough to allow for full pivoting of the opening doors. Moreover, such sliding doors also allow the vehicles to have larger door openings.

Accordingly, sliding doors provide access to large door openings without requiring a large area adjacent to the vehicle which would be required for a door that pivots on its hinge. In one configuration, a power sliding door is supported and guided by an upper track, a center track and a lower track. An upper roller is attached to the power sliding door and travels in the upper track. A lower roller is attached to a lower portion of the sliding door and runs or travels in the lower track. A hinge and roller assembly is pivotally attached to a rear portion (e.g., towards the rear of the vehicle) of the door between the upper and lower portions of the door. The hinge and roller assembly is also received in the track to allow for sliding or movement of the door.

In other applications, lift gates are provided for access to the rear portion of the vehicle so that items may be stowed in the back of the vehicle.

In addition to the usage of sliding doors and lift gates in vehicles, power drive systems have been implemented wherein automatic opening, closing, locking and unlocking of the sliding door or lift gate is facilitated through a drive system coupled to the sliding door. Presently, some sliding doors are driven through cables attached to the forward and aft sides of the center roller hinge (e.g., a hinge mounted towards the center of the door with respect to the upper and lower edges of the same). With regard to lift gates the same are driven by cables, chains, belts or other equivalent items capable of providing the driving force for movement of the lift gate from a closed position to an open position and back to a closed position.

In addition to the power driving system, a control system is necessary to operate the power drive system and one necessary aspect of the control system is that movement and position of the sliding door or lift gate must be tracked or known to the logic of the control system. In order to determine the movement and position of the sliding door or lift gate a sensor can be coupled to any one of the components that is driven (e.g., moved by the power driving system).

Accordingly, it is desirable to provide an apparatus and method for determining the movement of a vehicle door by a motor driven device. In addition, it is also desirable to provide an apparatus and method for determining the movement of a vehicle door, wherein the same is capable of determining very small movement of the vehicle door. Furthermore, it is also desirable to provide a compact motor drive unit that is capable of being installed in small areas of the vehicle.

### SUMMARY OF THE INVENTION

A drive assembly for a vehicle door, comprising: a motor having a driving member; a housing having a shaft rotatably received therein; an input member being rotatably received upon the shaft, the input member being operatively associated with the driving member, wherein rotation of the driving member causes rotation of the input member; an armature mounted on the input member; a rotor fixedly secured to the shaft, the rotor being cylindrical in shape and has a plurality of teeth positioned along the periphery of the rotor, the teeth being positioned in an equidistant manner; a coil mounted to the housing, the coil providing magnetic flux lines through the rotor to attract the armature when the coil is energized; and a sensor assembly mounted to the housing in a facing spaced relationship with respect to the plurality of teeth of the rotor, wherein rotational speed and direction of the rotor is detected by the sensor assembly.

A drive assembly for a vehicle door, comprising: a motor having a driving member; a housing having a shaft rotatably received therein; an input member being rotatably received upon the shaft, the input member being operatively associated with the driving member, wherein rotation of the driving member causes rotation of the input member; an armature mounted on the input member; a rotor fixedly secured to the shaft, the rotor being cylindrical in shape and has a plurality of teeth positioned along the periphery of the rotor, the teeth being positioned in an equidistant manner; a coil mounted to the housing, the coil providing magnetic flux lines through the rotor to attract the armature when the coil is energized thereby coupling the input member to the rotor, wherein the magnetic flux lines travel through a portion of the rotor and the armature but not through the plurality of teeth of the rotor; and an inductance sensor assembly mounted to the housing in a facing spaced relationship with respect to the plurality of teeth of the rotor, wherein rotational speed and direction of the rotor is detected by the inductance sensor assembly as the plurality of teeth of the rotor pass by the inductance sensor assembly.

A drive assembly for a vehicle door, comprising: a motor having a driving member; a housing having a shaft rotatably received therein; an input member being rotatably received upon the shaft, the input member being operatively associated with the driving member, wherein rotation of the driving member causes rotation of the input member; an armature mounted on the input member; a rotor fixedly secured to the shaft, the rotor being cylindrical in shape and has a plurality of teeth positioned along the periphery of the rotor, the teeth being positioned in an equidistant manner; a coil mounted to the housing, the coil providing magnetic flux lines through the rotor to attract the armature when the coil is energized thereby coupling the input member to the rotor; and a hall effect device mounted to the housing in a facing spaced relationship with respect to the plurality of teeth of the rotor, wherein the hall effect device comprises a magnet and an integrated circuit, wherein rotational speed and direction of the rotor is detected by the hall effect device as the plurality of teeth of the rotor pass by the hall effect device.

A modular drive assembly for a sliding door, comprising: a guide track having a hinge assembly slidably received therein; a pair of pulleys disposed on either end of said guide track, said pair of guide pulleys being disposed adjacent to a path of travel of said hinge assembly within said guide track, said path of travel being defined by a closed door limit and an open door limit; and a pair of cables each having an end that is secured to said hinge assembly and the other end is secured to a cable drum of a motor drive unit mounted to said guide track, said motor drive unit being configured to rotate said cable drum, wherein said cable drum is also capable of freely rotating within said motor drive unit when said motor drive unit is not rotating said cable drum, wherein rotation of said cable drum causes said hinge assembly to move in said guide track as one of said cables wraps onto said cable drum while the other one of said cables wraps off of said cable drum, wherein said hinge assembly passes a portion of one of said pair of pulleys when said hinge assembly is at said closed door limit and said hinge assembly passes a portion of the other one of said pair of pulleys when said hinge assembly is at said open door limit, wherein the motor drive unit comprises: a motor having a driving member; a housing having a shaft rotatably received therein, the motor being mounted to the housing; an input member being rotatably received upon the shaft, the input member being operatively associated with the driving member, wherein rotation of the driving member causes rotation of the input member; an armature mounted on the input member; a rotor fixedly secured to the shaft, the rotor being cylindrical in shape and has a plurality of teeth positioned along the periphery of the rotor, the teeth being positioned in an equidistant manner; a coil mounted to the housing, the coil providing magnetic flux lines through the rotor to attract the armature when the coil is energized thereby coupling the input member to the rotor; an inductance sensor assembly mounted to the housing in a facing spaced relationship with respect to the plurality of teeth of the rotor, wherein rotational speed and direction of the rotor is detected by the inductance sensor assembly as the plurality of teeth of the rotor pass by the inductance sensor assembly; and the cable drum is fixedly secured to the shaft, wherein rotation of the cable drum by a force other than the motor will cause rotation of the rotor when the coil is not energized and rotational speed and direction of the rotor is detected by the inductance sensor assembly as the plurality of teeth of the rotor pass by the inductance sensor assembly.

### BRIEF DESCRIPTION OF THE DRAWINGS

FIG. 1 is a perspective view of a vehicle with a sliding door and a lift gate;

FIG. 2 is a perspective view of a door track and a motor drive unit for driving a sliding door of a vehicle;

FIG. 3 is a view along lines 3-3 of FIG. 2;

FIG. 4 is a schematic diagram of inductance sensor assembly;

FIGS. 5A and 5B illustrate the eddy currents generated in the inductance sensing assembly as rotor teeth pass by;

FIGS. 6-6C illustrate a rotor constructed in accordance with exemplary embodiments of the present invention;

FIGS. 7 and 8 illustrate the output signals of the inductance sensing assembly;

FIGS. 9A and 9B are perspective views of a housing for the inductance sensing assembly;

FIG. 10 is cross-sectional view of an alternative motor drive unit for use in power sliding door or lift gate applications;

FIG. 11 is top plan view of a motor drive unit constructed in accordance with an exemplary embodiment of the present invention;

FIG. 12 is a view along lines 12-12 of FIG. 11; and

FIG. 13 is a view along lines 13-13 of FIG. 11.

### DETAILED DESCRIPTION OF EXEMPLARY EMBODIMENTS

Exemplary embodiments of the present invention relate to an apparatus and method for providing a compact drive device for use in vehicular applications. In one exemplary embodiment, the drive device is contemplated for providing a driving force to at least one driving cable of a sliding door of a vehicle. In another exemplary embodiment, the drive device is contemplated for providing a driving force to at least one driving member of a lift gate of a vehicle.

Prior apparatus and methods for providing and/or effectuating moving of a sliding door of a vehicle are found in U.S. Pat. Nos. 5,046,283; 5,313,795; 5,319,880; 5,319,881 and 5,323,570 the contents of which are incorporated herein by reference thereto. Other related applications include U.S. patent applications Ser. Nos. 10/798,733 and 10/798,792 both filed Mar. 11, 2004, the contents of which are incorporated herein by reference thereto.

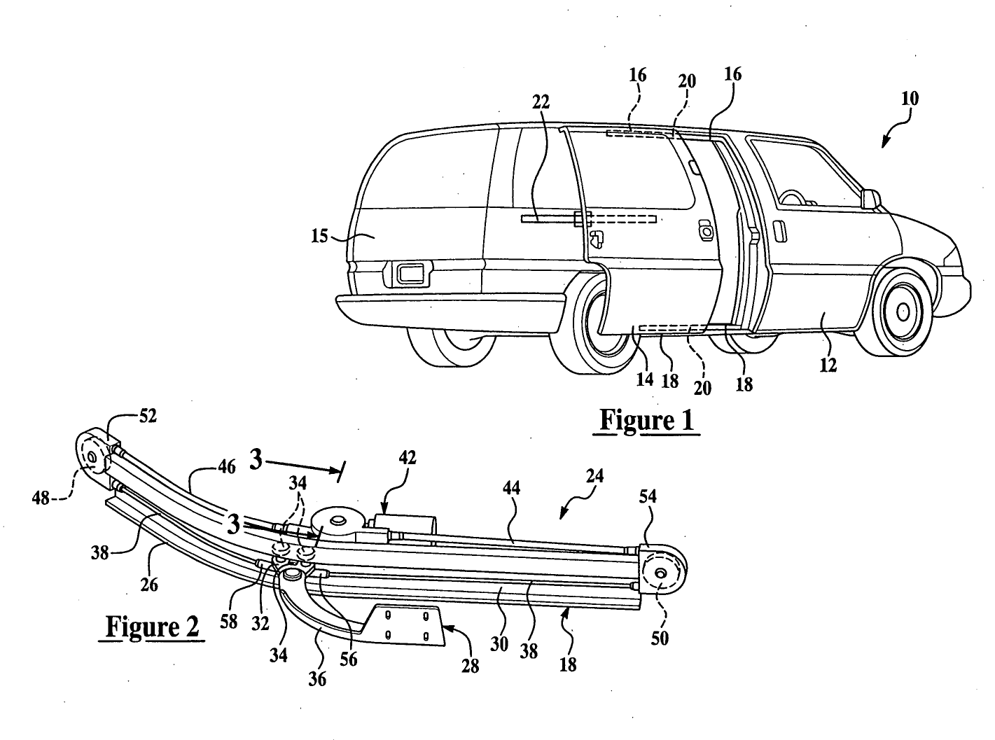

Referring now to FIG. 1, a vehicle 10 with a front pivoting door 12 and a power sliding door 14 is illustrated. Vehicle 10 also comprises a lift gate 15. Here and in a non-limiting embodiment, power sliding door 14 is guided by rollers that are slidably received in an upper track 16 and a lower track 18. The rollers 20 are configured to be received in upper track 16 and lower track 18. In addition to upper track 16 and lower track 18, and in accordance with an exemplary embodiment, a center track 22 is also provided. Center track 22 is also configured to receive and engage a roller 20 that is coupled to sliding door 14. Of course, exemplary embodiments of the present invention are contemplated for use with other sliding door configurations.

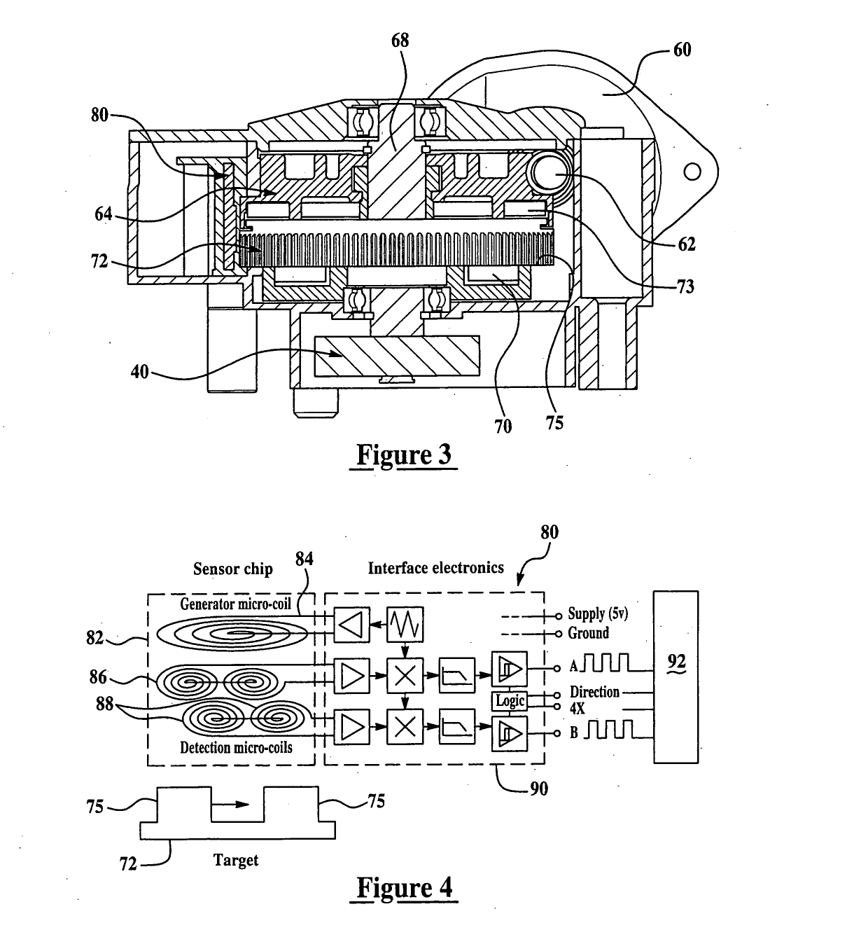

Referring now to FIGS. 2 and 3, a modular power sliding door system is illustrated. As illustrated, a modular system 24 is provided wherein all the drive components are attached to a lower sliding door track and the system is easily installed as a single unit. As shown, modular system 24 comprises a door track 26 for defining a path of travel for the sliding door. The path of travel defines an open position of the door and a closed position of the door. In accordance with an exemplary embodiment system 24 is a cable drive system wherein cables are manipulated to drive a hinge or hinge assembly 28 which is secured to the sliding door.

Door track 26 defines a channel 30 for slidably receiving a portion 32 or lower roller hinge 28. Door track 26 can be manufactured out of a steel stamping of any equivalent thereof wherein the curvature of the track is easily defined as well as the configuration of the channel. The door track is configured to be installed as a complete unit into the vehicle, which in accordance with one exemplary embodiment will be installed within a cavity of a lower portion of a vehicle defined by a vehicle rocker panel.

One method or means for allowing portion 32 to be slidably received within channel 30 is to provide rollers 34, which will allow hinge 28 to slide therein. Also, portion 32 is pivotally secured to a mounting portion 36 of hinge 28. The pivotal securement of portions 32 and 36 will allow for the proper movement of the sliding door as it moves along the contour of track 26, which is configured to match the contour of the vehicle. It is, of course, understood that the hinge 28 may comprise a single unit with the pivotal movement being facilitated by the securement of one end to the door and the other end to the track.

In an exemplary embodiment, a pair of cables 38 are secured to hinge 28. One cable 38 is secured to a forward side of the hinge and the other is secured to the rearward side of the hinge and the other ends of the cables are each secured to a single drum or output member 40 of a motor drive unit 42. The cables are attached to either side of the drum such that while one cable raps off the drum the other will rap on. Alternatively, drum 40 may comprise two drums that are secured to each other by a spring biasing means in order to provide tension to cables 38 as the hinge assembly travels within the guide track. In yet another alternative embodiment, drum 40 is configured to have drums of varying dimensions or diameters wherein a smaller diameter portion is used to provide a greater torque to the cable. The smaller diameter is contemplated for used during the closing or latching portion of door travel wherein higher forces are preferred.

The cables also pass through conduits 44 and 46. Conduits 44 and 46 extend out from the housing of motor drive unit 42 in opposite directions. Conduits 44 and 46 provide a means for protecting the cables from being damaged or interfered with as they wrap onto and off of cable drum 40. Disposed at either end of the track is a pair of cable pulleys 48 and 50. Pulleys 48 and 50 are rotatably mounted to the ends of track 26. Pulleys 48 and 50 allow the cable to transition from the conduit into the channels of track 26 and ultimately to the tensioners or alternatively the cables are directly secured to a portion of hinge 28. In yet another alternative and in lieu of spring tensioners 56 and 58 either, or both pulleys 48 and 50 can be secured to the guide track by a member movably connected to the guide track wherein a biasing member applies a biasing force to the pulley or the member the pulley is mounted to as the hinge assembly transitions through the guide track. The cables extend out to either side of the lower roller hinge where they are attached to the same through spring tensioners 56 and 58. An intended purpose of tensioners 56 and 58 is to allow for the carrying length of cable needed throughout the sliding door's travel, especially through the bend in the track (e.g., the bend portion of the track necessary to transition the sliding door into its fully closed position). The purpose of the tensioners is to allow for a varying length of cable needed throughout the sliding door's travel, especially through the bend in the track where increased forces may be required to pull the door into a locked position. Pulleys 48 and 50 are disposed within pulley housings 52 and 54, respectively. Housings 52 and 54 enclose and protect the pulleys and the cable from debris and contaminates that may affect performance of the same (e.g., increase resistance or cause undesirable noise or vibrations).

Accordingly, the cable pulleys provide a means for guiding and completing the cable loop which causes the desired movement of the hinge. As discussed above, the movement of the hinge is facilitated by winding one of the cables onto the cable drum while allowing the other cable to unwind therefrom thus, allowing the hinge to slide within the track.

Motor drive unit 42 provides the necessary driving force for the modular system 24. More particularly, motor drive unit 42 provides the force for rotating cable drum 40 in order to effect the desired movement of hinge 28 and ultimately sliding door 14. In accordance with an exemplary embodiment motor drive unit 42 is configured to have a height profile not greater than the height profile of the modular drive unit or track 26. Thus, the exemplary embodiment disclosed herein requires no additional vehicle space as would be required for only track 26 and the hinge disposed therein. Moreover, modular drive unit 24 is easily installed in its operative location, as the height of the system is the same as a receiving cavity planned for use of track 26. This is accomplished by providing a compact motor drive unit that is capable of generating the required torque or force to rotate cable drum 40. However, it is also contemplated in applications where there is additional room for installation of the modular unit, the motor drive unit housing may be slightly larger than the guide track. In order to reduce the profile of the motor drive unit, a sensing assembly that is used for monitoring the position, speed and direction of the vehicle door is internally incorporated into the housing to reduce the profile of the unit. However, and since it is desirable to provide a low profile housing there is not a lot of room in the internal cavity of the housing thus, is desirable to provide a small sensing assembly that provides an accurate output.

Referring now to FIG. 3, an exemplary embodiment of the motor drive unit is illustrated. As illustrated, motor drive unit 42 comprises a motor 60 for driving a shaft having a worm gear 62. Worm gear 62 is configured to threadingly engage a gear or input member 64. Gear 64 is rotatably mounted upon a shaft 68 rotatably received within an internal cavity defined by the housing of the motor drive unit. Thus, gear 64 is capable of rotational movement about shaft 68. In accordance with an exemplary embodiment, shaft 68 is rotatably received in the housing by for example a pair of bearing arrangements, wherein shaft 68 is perpendicularly positioned with respect to the driving member or shaft of the motor comprising a worm gear configured for engaging gear 64. Of course, other (non-perpendicular) angular configurations between gear 64 and shaft 68 are contemplated.

The motor drive unit further comprises an electromagnetic clutch for coupling and uncoupling gear or input member 64 to shaft 68 via a rotor fixedly secured to the shaft wherein the electromagnetic clutch is activated for powered movement of the vehicle door. Thus, once gear 64 is electromagnetically coupled to the rotor, rotation of gear 64 causes rotation of shaft 68 and when the gear is no longer secured or electromagnetically coupled to the rotor gear 64 can rotate freely about-shaft 68. In other words, when the electromagnetic clutch is not engaged the rotor and the shaft can freely rotate while gear 64 remains stationary. As is known in the related arts an electromagnetic clutch comprises a stationary coil 70 for generating an electromagnetic field in order to couple or uncouple a first frictional surface or rotor 72 to another frictional surface or armature or other equivalent item 73. Accordingly, motor drive unit 42 provides electro/mechanical transmission of torque via mechanical engagement, which is facilitated through an excitation that is provided to the coil. In order to actuate the clutch a voltage/current is applied to the coil, wherein the coil becomes an electromagnet and produces magnetic lines of flux. The flux is then transferred through a small air gap between the coil and a rotor. A portion of the rotor becomes magnetized and sets up a magnetic loop that attracts an armature wherein a frictional force is applied at contact. In accordance with an exemplary embodiment, the coil, the rotor and the armature are configured such that the magnetic lines of flux do not pass through the teeth of the rotor disposed about the periphery of the rotor.

As shown, and in accordance with an exemplary embodiment, rotor 72 is fixedly secured to the shaft and armature 73 is fixedly secured to gear 64, which rotates freely about shaft 68. Thus, rotation of shaft 68 without the coil being energized will cause rotation of rotor 72 and output gear or cable drum 40 while gear 64 and armature 73 are rotatably mounted upon shaft 68. Accordingly, shaft 68 is capable of being driven by rotation of drum 40 (e.g., sliding of the door or pivoting of the lift gate) when the coil is not energized and the armature of gear 64 is not engaging rotor 72.

Accordingly, rotor 60 will drive or rotate gear 64 and the cable drum will not be rotated by the motor until the coil is energized and the electromagnetic field or magnetic flux generated by coil 70 draws armature 73 towards rotor 72 as is known in the related arts. Thus, when the electromagnetic clutch is engaged the door can be powered open or closed by motor 60. When the clutch is released or the electromagnetic clutch is not engaged the door can be moved freely because the cable drum is allowed to move freely as there will be no frictional engagement between the two friction plates. Operation of the motor and the electromagnetic clutch to open and close the vehicle sliding door is facilitated by a controller in operable communication with the necessary components of the motor drive unit.

Although not specifically shown it is contemplated that motor drive unit 42 can be used to open and close a vehicle lift gate.

In addition and in an exemplary embodiment, rotor 72 further comprises a plurality of teeth 75 disposed about the periphery of the rotor. Teeth 75 are configured to provide a means for determining the speed and direction of rotation of the rotor as an inductive sensing assembly 80 is secured to the housing in a facing spaced relationship with respect to teeth 75 of rotor 72. The direction of rotation of the rotor and its speed is used to determine the movement and position of the vehicle door coupled to the rotor via shaft 68, output member or cable drum 40, cables 38 and the hinge assembly. In addition, sensing assembly 80 can also be used to determine if an obstacle is preventing movement of the vehicle door. Sensing assembly 80 will provide signals indicative of movement of rotor 72, which may be attributable to manual movement of the door or powered movement of the door by the motor when the electromagnetic clutch is engaged. This is due to the fact that the rotor will rotate in either the manual or power mode and gear 64 is rotationally mounted about shaft 68. Movement, direction and speed of the door is determined by monitoring the movement of the rotor, wherein signals indicative of rotor movement and speed are inputted into a control algorithm comprising logic for converting the rotor movement and speed into vehicle door movement, location and speed. Sensing assembly 80 is used to determine the position, speed and direction of the vehicle door, wherein the sensing assembly provides two output channels, which is commonly called a quadrature output type sensor. The signals indicative of rotor movement and speed are provided to a controller or system having a microprocessor, microcontroller or other equivalent processing device capable of executing commands of computer readable data or program for executing a control algorithm. In order to perform the prescribed functions and desired processing, as well as the computations therefore (e.g., determining the movement, direction and speed of the vehicle door as well as operating the electromagnetic clutch and the motor), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include input signal filtering to enable accurate sampling and conversion or acquisitions of such signals from communications interfaces. As described above, exemplary embodiments of the present invention can be implemented through computer-implemented processes and apparatuses for practicing those processes. Movement, direction and speed of the door is important as most power sliding door systems or power lift gates are operated by a control system wherein various inputs are required for proper operation.

Referring now to FIGS. 3 and 4, and in accordance with an exemplary embodiment, sensing assembly 80 is an inductance type of sensing assembly comprising a sensing chip 82, which is positioned to provide signals to a control module as the teeth of the rotor rotate or move past the sensing chip. Disposed on the sensing chip are a generator coil 84 and two pairs of detection coils 86 and 88. Alternatively, a single generator coil and one pair of detection coils can be used. The detection coils are connected in a differential arrangement to reject a common mode signal. The sensor also comprises an electronic interface 90, which comprises an excitation for the generator coil and two read outs A and B. The excitation generates an AC magnetic field at a frequency of several hundred kHz. Accordingly, an AC voltage is induced in the sensing coils by the magnetic field of the excitation coil. As illustrated, a differential arrangement of two sensor coils is provided to eliminate common mode disturbances. Electronic interface 90 provides a dedicated application specific integrated circuit (ASIC) or printed circuit board for generating the excitation current, amplifying the measured voltages, and demodulation of the signal, wherein the signal is presented in an analog or digital format. The readout electronics of the ASIC of the electronic interface will extract the amplitude variation of the high frequency signal due to the presence of a metallic target passing by the detection coils (e.g., the teeth of the rotor) which disturbs or redirects the fields generated by the generation coil and the detection coils. Thus, the generated magnetic field is amplitude-modulated by the movement of the metal teeth of the rotor. In accordance with an exemplary embodiment four sensing coils are connected in differential pairs to pick up the modulated field and provide signals to a corresponding circuit. In one embodiment, the output stage of the electronic interface is a 1^{st} order low-pass filter and a comparator. Accordingly, rotation of the teeth of the rotor is sensed and signals are provided to a controller 92. In accordance with one non-limiting exemplary embodiment the plurality of output signals have a periodicity identical to the plurality of teeth of the rotor and the phase difference between the channels of the sensing assembly is defined by the ratio of width between two rising edges over the cycle width. The use of this type of inductance sensing assembly negates the need for a permanent magnet, which allows for design flexibility and improves resolution or accuracy of the sensing device.

In accordance with an exemplary embodiment, the sensor face operates when it is in a facing spaced relationship with respect to the rotating teeth of the rotor. Exemplary distances are found in the range defined by 0.1 mm-0.9 mm, with an optimum distance of 0.5 mm. Of course, distances greater or less than the aforementioned values are contemplated to be within the scope of the present invention.

An example of sensing assembly 80 is a digital inductive position, speed and direction sensor PO1210 that is currently available from Posic. Additional information on the sensing assembly of Posic is found in the documents of the attached Information Disclosure Citation entitled: “POSIC, PO1210-DS-V2B” pages 1-3, the contents of which are incorporated herein by reference thereto. Additional information on the sensing assembly of Posic is also found at their website http://www.posic.ch. In addition, U.S. Pat. No. 6,043,644, the contents of which are incorporated herein by reference thereto, provides further details of the inductance sensing assembly intended for use with exemplary embodiments of the present invention.

As described in the Posic literature and U.S. Pat. No. 6,043,644 and in accordance with an exemplary embodiment, the generator and detection coils are separate planar coils (e.g., a flat coil whose thickness is small with respect to the other dimensions) formed from a spiral conductor wherein the conductor is deposited on a silicon substrate by any suitable means. The generator or primary coil generates a first magnetic field covering, at least, the surface of a notch and a tooth of the rotor. The detection or secondary coils pick up the magnetic field induced by the generator coil. In accordance with an exemplary embodiment the detection coils are disposed between the teeth of the rotor and the generator coil. In accordance with an exemplary embodiment, the detection coils are smaller than the generator coil and each of the detection coils covers a surface corresponding to the surface of a tooth or a notch only and each detection coil picks up a part of the magnetic field generated by the generator coil. Of course, the dimensions and the position of the coils may be adapted to the particular dimensions of the rotor.

The magnetic flux, generated by the generator coil is distributed between the detection coils wherein the configuration of the detection coils allows the difference between the fields detected by the detection coils to be measured independently of any variations in the value of the field generated by the generator coil. This differential structure is preferably obtained by arranging the detection coils in a plane facing the generator coil. Of course, other configurations are contemplated to detect part of the flux of the magnetic field generated by the generator coil.

In operation, the primary or generator coil and the detection or secondary coils are coupled with a differential transformer and the presence of the rotor teeth changes the lines of the magnetic field generated by generator coil so that a difference appears between the fields picked up by the detection coils and the difference between the fields picked up by the detection coils allows the presence or passing of a metal tooth of the rotor to be detected.

In accordance with an exemplary embodiment, the generator coil is supplied with an alternating current, so that an alternating signal appears at the terminals of detection coils and the amplitude of the signal picked up by the detection coils is changed by the presence of a tooth wherein the amplitudes are a function of the spacing between a detection coil and a tooth of the rotor. In addition, the stop position of the rotor can be determined, by measuring the amplitude of the signal picked up by a one of the detection coils and comparing it to the amplitude of the signal picked up by the other one of the detection coils thus, the sensing device is able to distinguish between the presence and the absence of a rotor tooth.

The measurement of the rotational direction is based upon the fact that the detection coils are staggered with respect to the teeth of the rotor. Thus, the modulation of the signal at the terminals of detection coils is phase shifted. In addition, this phase shift corresponds to the spacing of the coils relative to the spacing of the teeth.

In addition, and in view of contemplated uses the sensor needs to meet automotive electrical specifications, which include but are not limited to the following requirements over voltage protection, reverse battery protection, reverse polarity protection and electromagnetic capabilities.

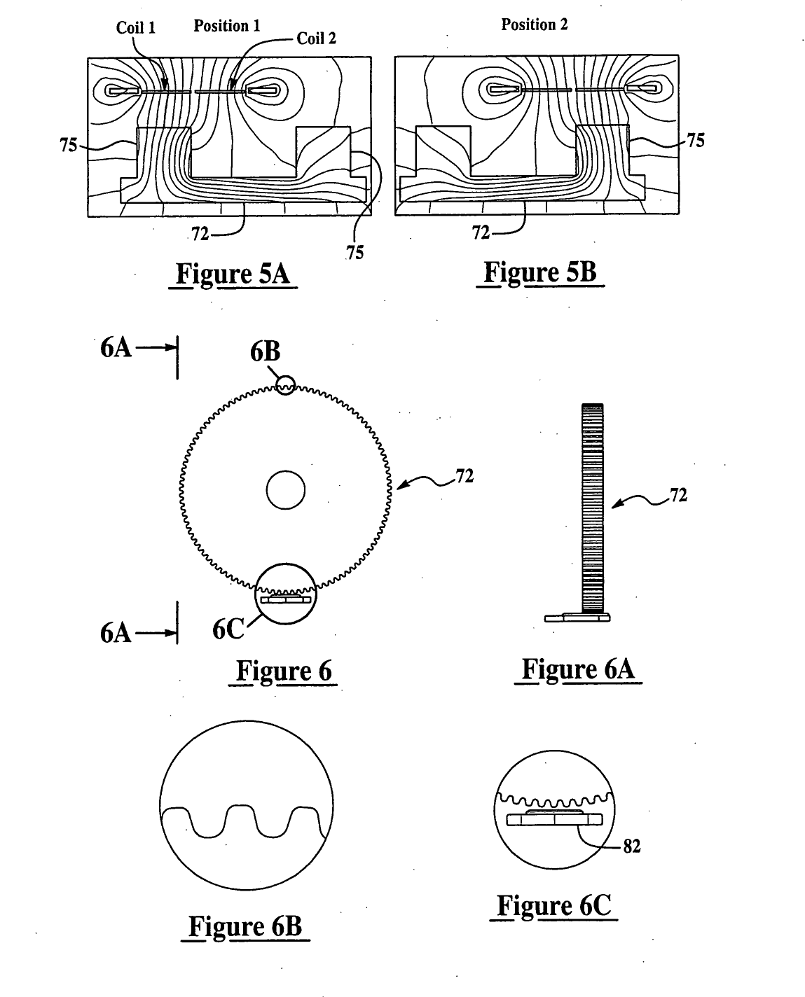

FIGS. 5A and 5B show magnetic fields generated as the teeth of an item such as rotor 72 pass by the coils of the inductance sensing assembly. Referring now to FIGS. 6-6C details of an exemplary rotor and teeth dimensions are illustrated. In accordance with an exemplary embodiment rotor 72 has 102 teeth mounted about a periphery having a diameter of approximately 70 millimeters, such a number of teeth will provide high resolution of the movement of the sliding door or the lift gate, which is not presently available with rotating magnet sensors presently used in other motor drive mechanisms. For example, magnet sensors are dependent upon the number of North and South poles that can be disposed in a magnet or in particular a ring magnet. Thus, resolution is dependent upon magnet size. In other words, the larger the magnet the more poles can be disposed on the same. Conversely, the smaller the magnet the smaller number of poles are provided and thus, such a magnet will not be able to provide as much resolution and the accuracy depends upon the number of poles.

In contrast, and in accordance with an exemplary embodiment, rotor 72 is much more accurate as each tooth provides much more accuracy in determining speed, direction and movement of the driven item (e.g., the vehicle door). For example, movement of two teeth past the sensing assembly will allow speed and direction of the door to be determined. In accordance with an exemplary embodiment, and as illustrated in FIG. 6C each tooth has a pitch of approximately 2.16 millimeters. Of course, it is understood that rotors having dimensions greater or less than the aforementioned values as well as teeth numbers greater or less than the aforementioned values are considered to be within the scope of the present invention.

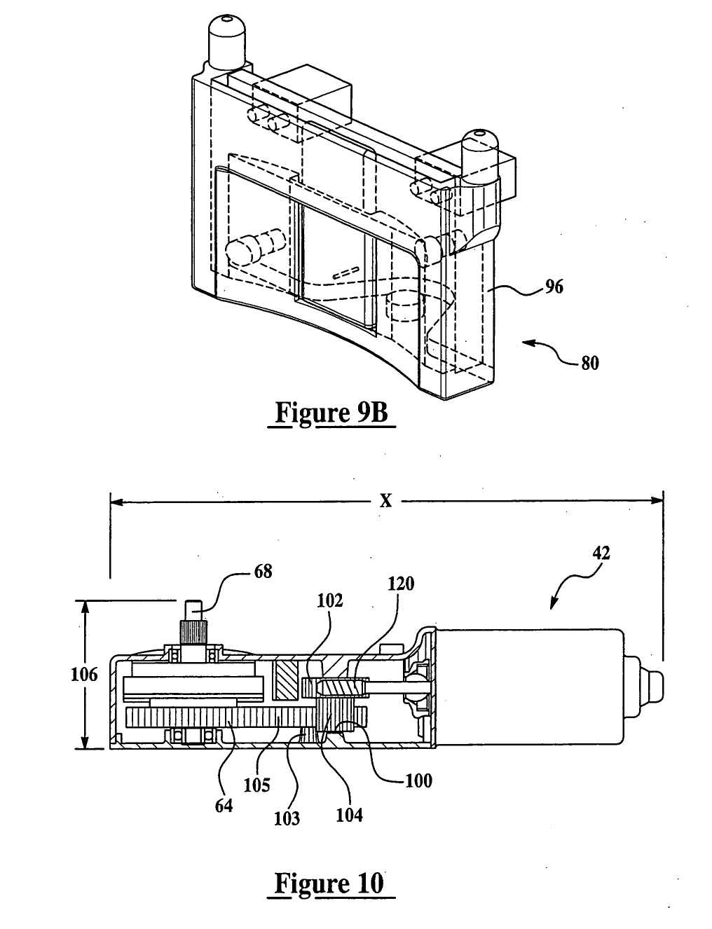

FIGS. 9A and 9B illustrates a housing 96 contemplated for housing the printed circuit board comprising the inductance sensing assembly 80. Housing 96 may be mounted to the motor drive unit by any suitable means including but not limited to heat staking, adhesives, riveting etc. and the sensing assembly is also mounted within housing 96 by any suitable means.

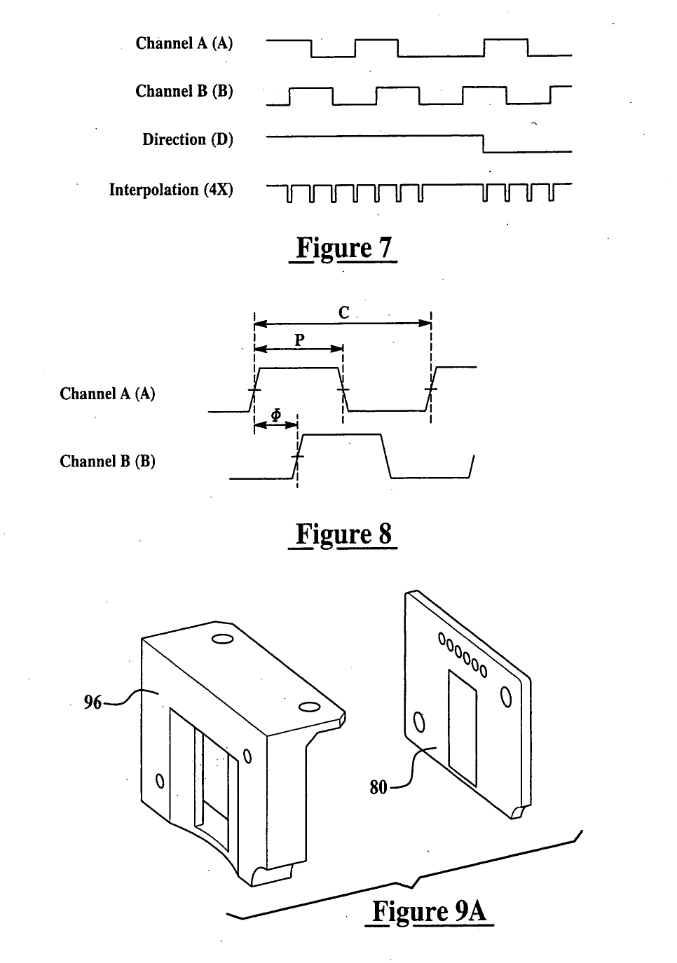

FIGS. 7 and 8 illustrate the output signals of the inductive sensing assembly. As shown in FIG. 7 the ratio of the pulse-width (P) and the cycle width (C) will provide the duty cycle, wherein the phase difference is the difference between the two rising edges over the cycle-width.

In an alternative embodiment, sensing assembly 80 in FIG. 3 is replaced with a Hall effect sensing assembly comprising an integrated circuit and magnet combination for digital sensing of the teeth 75 of the rotor 72 wherein a stationary magnet and a Hall effect IC has been configured to the magnetic circuit and signal processing occurs in response to magnetic signals created by the presence of the rotor teeth or lack thereof. An example of such a device is manufactured by Allegro Microsystems, Inc. under the product identification of ATS650LSH, ATS651LSH and equivalents thereof. Further information is found at the website for Allegro Microsystems, Inc., http://www.allegromicro.com as well as the publication of Allegro Microsystems, Inc. found in the attached Information Disclosure Citation, the contents of which are incorporated herein by reference thereto. In this embodiment, the movement of the rotor teeth past the Hall Effect sensing assembly will provide detectable changes in the magnetic field of the Hall Effect device.

In order to operate the power sliding door of vehicle 10 it is contemplated that a sensing system will be installed in vehicle 10 such that signals received from an input device (e.g., switch or key fob) will cause motor drive unit 42 to open or close the door. The sensing system will provide the necessary signals to a control module or microprocessor having an algorithm for executing commands pursuant to signals received (e.g., Channels A and B) from the sensors including sensing assembly 80. An example of a sensor and controller arrangement can be found in U.S. Pat. Nos. 5,263,762; 5,350,986; 5,396,158; 5,434,487; and 6,247,373 the contents of which are incorporated herein by reference thereto. It is of course understood that the aforementioned U.S. patents merely provide examples of sensor and controller arrangements capable of being used with the present invention.

FIG. 10 illustrates another alternative exemplary embodiment, here a second shaft 100 is rotatably received and provided in the housing and the worm gear 120 of the motor engages a first gear 102 mounted to shaft 100 and shaft 100 further comprises a second gear 104, which is configured and positioned to engage another gear 105 mounted on a shaft 103 wherein gear 105 is configured and positioned to engage gear 64. The configuration of gear 102 and gear 104 allows the torque of the motor to be stepped up or the speed of the motor to be stepped down, if necessary, for engagement and driving of the gear assembly. Furthermore, the use of shafts 100 and 103 allow for design flexibility (e.g., the diameters of the engaging gears may be varied as gear 105 acts as an idler gear).

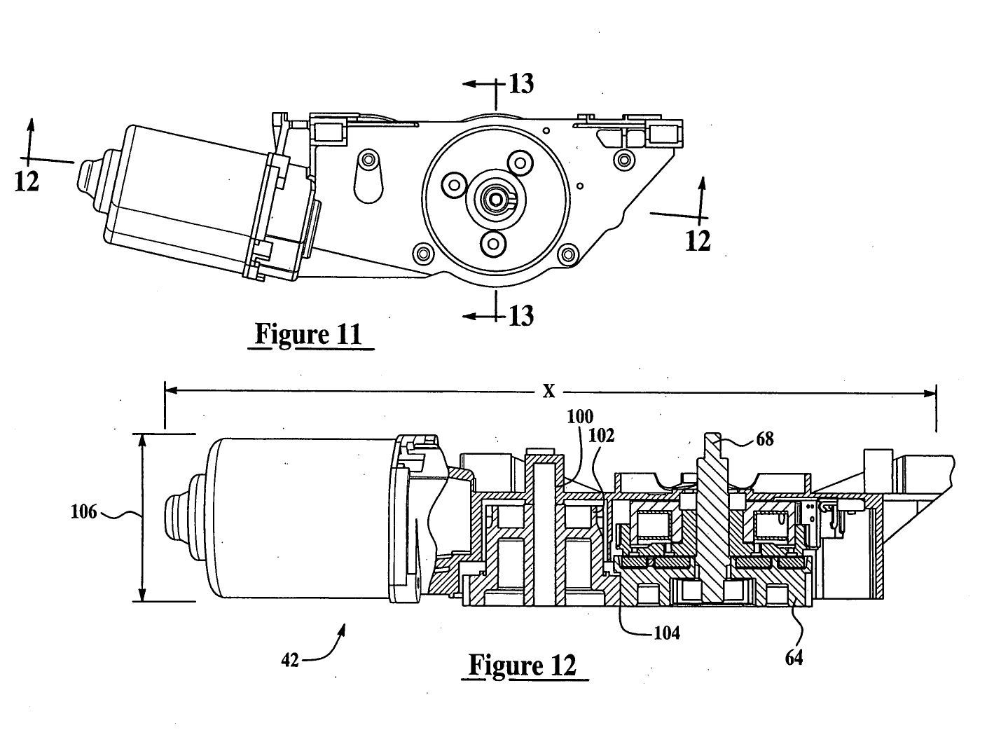

Alternatively and referring now to FIGS. 11-13, gear 104 is configured and positioned to directly engage gear 64 thereby negating the need for gear 105 and shaft 103 and gear 102 is directly driven by worm gear 120 of the motor (not shown in this Figure). This and the previous design allows the worm drive of the motor to be centrally located within a height profile 106 of motor drive unit 42 (e.g., a distance between the top of output member 40 including any covering and the opposite wall of the housing proximate to the opposite end of shaft 68, while still allowing the input force to be provided at an end or proximate to an end portion of shaft 68 without increasing the height profile of the motor drive unit. Thus, this design allows for use in smaller height profile areas while the length in the “x” direction can be lengthened. Also, first gear 102 and second gear 104 may be configured to provide a gear reduction ratio from worm gear 120 to gear 64. In an exemplary embodiment gears 102 and 104 are configured as a single member integrally molded about shaft 100 or alternatively, the gears are mounted onto a separate shaft 100. In accordance with an exemplary embodiment, gears 64, 102, 104 and 105 are each configured to have dimensions (e.g., diameter and number of teeth) to provide the desired transfer of torque or force to output member 40 from worm drive 120 of motor 60.

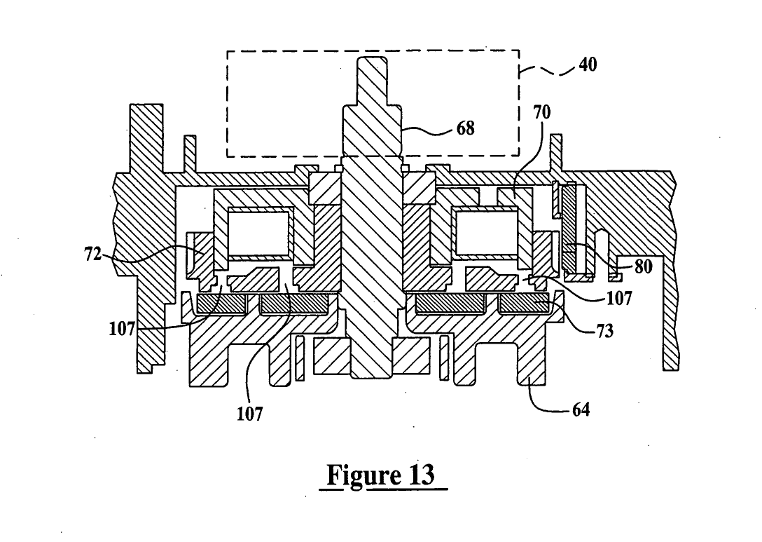

As illustrated in FIG. 13, rotor 72 has apertures or openings 107, which are positioned to direct the flux path generated by the coil through the rotor in order to attract armature 73 to rotor 72. In accordance with an exemplary embodiment, the magnetic flux lines travel through a portion of the rotor and the armature but not through the plurality of teeth of the rotor. This provides for more accurate measurement of the teeth as they pass by the sensing assembly (Hall Effect or inductance sensing assembly) as the flux path will not interfere with the sensing assembly.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A drive assembly for a vehicle door, comprising:
a motor having a driving member;
a housing having a shaft rotatably received therein;
an input member being rotatably received upon the shaft, the input member being operatively associated with the driving member, wherein rotation of the driving member causes rotation of the input member;
an armature mounted on the input member;
a rotor fixedly secured to the shaft, the rotor being cylindrical in shape and has a plurality of teeth positioned along the periphery of the rotor, the teeth being positioned in an equidistant manner;
a coil mounted to the housing, the coil providing magnetic flux lines through the rotor to attract the armature when the coil is energized thereby coupling the input member to the rotor, wherein the magnetic flux lines travel through a portion of the rotor and the armature but not through the plurality of teeth of the rotor; and
an inductance sensor assembly mounted to the housing in a facing spaced relationship with respect to the plurality of teeth of the rotor, wherein rotational speed and direction of the rotor is detected by the inductance sensor assembly as the plurality of teeth of the rotor pass by the inductance sensor assembly.

2. The drive assembly as in claim 1, wherein the vehicle door is a lift gate or a sliding door.

3. The drive assembly as in claim 1, wherein the inductance sensing assembly comprises a sensor chip with interfacing electronics, wherein the interfacing electronic provides an excitation to a generating micro-coil of the sensor chip for generating a magnetic field, which is varied by the plurality of teeth of the rotor as the rotor is rotated and wherein the sensing chip further comprises two pairs of detection coils arranged to eliminate common mode disturbances.

4. The drive assembly as in claim 3, wherein the interfacing electronics is configured to provide two output channels each providing a signal indicative of variations in a magnetic field induced by the generating micro-coil and sensed by the two pairs of detection coils, wherein the signals of the two output channels is provided in either a digital or analog format and the signals of the two output channels are provided to a microprocessor configured to control the drive assembly.

5. The drive assembly as in claim 4, wherein the interfacing electronics is configured to provide an output indicative of a direction and a speed the rotor is rotating after two of the plurality of teeth pass by the inductance sensor assembly.

6. The drive assembly as in claim 5, wherein the rotor has 102 teeth mounted about a periphery having a diameter of approximately 70 millimeters and each tooth has a pitch of approximately 2.16 millimeters.

7. The drive assembly as in claim 5, wherein the plurality of output signals have a periodicity identical to the plurality of teeth of the rotor.

8. The drive assembly as in claim 5, wherein a second shaft is rotatably received in the housing, the second shaft having a gear assembly comprising a first gear portion and a second gear portion, wherein the first gear portion has a diameter smaller than the second gear portion and the first gear portion is configured to engage the driving member of the motor and the second gear portion is configured to engage the input member, wherein a height of the housing is no greater than a corresponding dimension of a housing of the motor.

9. The drive assembly as in claim 8, wherein the first gear portion is configured to engage the driving member and the second gear portion is configured to engage the input member.

10. The drive assembly as in claim 8, further comprising an output member fixedly secured to the shaft, wherein rotation of the output member by a force other than the motor will cause rotation of the shaft and the rotor when the coil is not energized and rotational speed and direction of the rotor is detected by the inductance sensor assembly as the plurality of teeth of the rotor pass by the inductance sensor assembly.

11. A drive assembly for a vehicle door, comprising:
a motor having a driving member;
a housing having a shaft rotatably received therein;
an input member being rotatably received upon the shaft, the input member being operatively associated with the driving member, wherein rotation of the driving member causes rotation of the input member;
an armature mounted on the input member;
a rotor fixedly secured to the shaft, the rotor being cylindrical in shape and has a plurality of teeth positioned along the periphery of the rotor, the teeth being positioned in an equidistant manner;
a coil mounted to the housing, the coil providing magnetic flux lines through the rotor to attract the armature when the coil is energized thereby coupling the input member to the rotor; and
a hall effect device mounted to the housing in a facing spaced relationship with respect to the plurality of teeth of the rotor, wherein the hall effect device comprises a magnet and an integrated circuit, wherein rotational speed and direction of the rotor is detected by the hall effect device as the plurality of teeth of the rotor pass by the hall effect device.

12. A modular drive assembly for a sliding door, comprising:
a guide track having a hinge assembly slidably received therein;
a pair of pulleys disposed on either end of said guide track, said pair of guide pulleys being disposed adjacent to a path of travel of said hinge assembly within said guide track, said path of travel being defined by a closed door limit and an open door limit; and
a pair of cables each having an end that is secured to said hinge assembly and the other end is secured to a cable drum of a motor drive unit mounted to said guide track, said motor drive unit being configured to rotate said cable drum, wherein said cable drum is also capable of freely rotating within said motor drive unit when said motor drive unit is not rotating said cable drum, wherein rotation of said cable drum causes said hinge assembly to move in said guide track as one of said cables wraps onto said cable drum while the other one of said cables wraps off of said cable drum, wherein said hinge assembly passes a portion of one of said pair of pulleys when said hinge assembly is at said closed door limit and said hinge assembly passes a portion of the other one of said pair of pulleys when said hinge assembly is at said open door limit, wherein the motor drive unit comprises:
a motor having a driving member;
a housing having a shaft rotatably received therein, the motor being mounted to the housing;
an input member being rotatably received upon the shaft, the input member being operatively associated with the driving member, wherein rotation of the driving member causes rotation of the input member;
an armature mounted on the input member;
a rotor fixedly secured to the shaft, the rotor being cylindrical in shape and has a plurality of teeth positioned along the periphery of the rotor, the teeth being positioned in an equidistant manner;
a coil mounted to the housing, the coil providing magnetic flux lines through the rotor to attract the armature when the coil is energized thereby coupling the input member to the rotor;
an inductance sensor assembly mounted to the housing in a facing spaced relationship with respect to the plurality of teeth of the rotor, wherein rotational speed and direction of the rotor is detected by the inductance sensor assembly as the plurality of teeth of the rotor pass by the inductance sensor assembly, and the cable drum is fixedly secured to the shaft, wherein rotation of the cable drum by a force other than the motor will cause rotation of the rotor when the coil is not energized and rotational speed and direction of the rotor is detected by the inductance sensor assembly as the plurality of teeth of the rotor pass by the inductance sensor assembly.

13. The modular drive assembly as in claim 12, wherein said modular drive assembly is secured to a vehicle as a single unit and the guide track is a lower guide track and said modular drive assembly provides an opening and a closing force to the sliding door and said curved portion corresponding to a portion of a periphery of a door opening in a vehicle.

14. The modular drive assembly as in claim 12, wherein said guide track is configured to provide a lower track of the sliding door and wherein the height of said motor drive unit is no greater than the height of said guide track.

15. The modular drive assembly as in claim 12, wherein said guide track defines a channel on one side and said motor drive unit is mounted to an opposite side of the guide track and the height of said motor drive unit is no greater than the height of said guide track.

16. The modular drive assembly as in claim 12, wherein said hinge assembly comprises a roller portion slidably received within a channel of said guide track and a mounting portion pivotally mounted to said roller portion, said mounting portion adapted to be secured to the sliding door.

17. The modular drive assembly as in claim 12, wherein a first conduit is disposed between a housing of said motor drive unit and a housing of one said pair of pulleys and a second conduit is disposed between said housing of said motor drive unit and a housing of the other one said pair of pulleys.

18. The modular drive assembly as in claim 17, wherein a tensioner is disposed between said hinge assembly and said end of each of said cables, said tensioner allows an operative length of said cables to change as said hinge assembly travels within said path of travel.

19. The modular drive assembly as in claim 12, wherein a second shaft is rotatably received in the housing, the second shaft having a gear assembly secured thereto, the gear assembly comprising a first gear portion and a second gear portion, wherein the first gear portion has a diameter smaller than the second gear portion and the first gear portion is configured to engage the driving member of the motor and the second gear portion is configured to engage the input member, wherein a height of the shaft is no greater than a corresponding dimension of a housing of the motor.

20. The modular drive assembly as in claim 19, wherein the first gear portion is configured to engage the driving member and the second gear portion is configured to engage the input member.

21. The drive assembly as in claim 20, wherein the inductance sensing assembly comprises a sensor chip with interfacing electronics, wherein the interfacing electronic provides an excitation to a generating micro-coil of the sensor chip for generating a magnetic field, which is varied by the plurality of teeth of the rotor as the rotor is rotated and wherein the sensing chip further comprises two pairs of detection coils arranged to eliminate common mode disturbances.

22. The drive assembly as in claim 21, wherein the interfacing electronics is configured to provide two output channels each providing a signal indicative of variations in a magnetic field induced by the generating micro-coil and sensed by the two pairs of detection coils, wherein the signals of the two output channels is provided in either a digital or analog format and the signals of the two output channels are provided to a microprocessor configured to control the drive assembly.

23. The drive assembly as in claim 22, wherein the interfacing electronics is configured to provide an output indicative of a direction and a speed the rotor is rotating after two of the plurality of teeth pass by the inductance sensor assembly.

24. The drive assembly as in claim 23, wherein the rotor has 102 teeth mounted about a periphery having a diameter of approximately 70 millimeters and each tooth has a pitch of approximately 2.16 millimeters.

25. The drive assembly as in claim 23, wherein the plurality of output signals have a periodicity identical to the plurality of teeth of the rotor.

26. The drive assembly as in claim 23, wherein a second shaft is rotatably received in the housing, the second shaft having a gear assembly comprising a first gear portion and a second gear portion, wherein the first gear portion has a diameter smaller than the second gear portion and the first gear portion is configured to engage the driving member of the motor and the second gear portion is configured to engage the input member, wherein a height of the housing containing the shaft and the second shaft is no greater than a corresponding dimension of a housing of the motor.
